(19) United States
(12) Patent Application Publication
(10) Pub. No.: US 2008/0280245 A1
(43) Pub. Date: Nov. 13, 2008

(54) PROTECTIVE - ODONTOGENIC DEVICE

(76) Inventor: Ned Bitsack, Merrimack, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(21) Appl. No.: 11/744,909

(22) Filed: May 7, 2007

(51) Int. Cl. A61C 7/08

(52) U.S. Cl. 433/23; 433/6

(57) ABSTRACT

A protective odontogenic device is provided as a malleable, cushioning material which is installed proximate the front and back region of at least the front teeth of a patient. The material helps protect against damage to the front teeth of a patient by a surgical armamentarium. The malleable, cushioning material may be contained in a carrier substrate prior to installation against the teeth of a patient. The carrier substrate may be provided in a generally horseshoe shaped form.

### TECHNICAL FIELD

The present invention relates to protective dental devices and more particularly, to device and method for preventing damage to teeth during intubation as a result of the use of surgical armamentarium in the mouth of a patient such as during administration of general anesthesia.

### BACKGROUND INFORMATION

Many medical procedures require the administration of general anesthesia to the patient. When general anesthesia is administered, an air passageway to the patient's lungs must be maintained. Endotracheal intubation is the placement of a tube into the trachea (windpipe) in order to maintain an open airway in patients who are unconscious or unable to breathe on their own. Oxygen, anesthetics, or other gaseous medications can then be delivered through the tube. The endotracheal tube inserted during the procedure maintains an open passage through the upper airway and allows air to pass freely to and from the lungs in order to ventilate them.

One common complication of intubation is broken teeth. In order to insert the tube into the patient's airway, the anesthesiologist utilizes a laryngoscope to clear a path in the patient's mouth and throat for the tube. The anesthesiologist often inadvertently applies too much pressure to the laryngoscope and against the patient's front teeth often causing chips or fractures in the teeth. This damage must be subsequently repaired by a dentist causing additional pain, discomfort, cost and/or inconvenience to the patient.

Accordingly, what is needed is a protective odontogenic device that can be installed prior to undergoing intubation which will cushion or absorb the force of a laryngoscope applied against the patient's teeth thereby eliminating or at least minimizing the risk of damage to the teeth.

### SUMMARY

The present invention features a protective odontogenic device for minimizing or preventing damage to at least the front teeth of a patient during a surgical procedure. Such a device is clean or sterile for insertion into the mouth of a patient. The odontogenic device comprises a satisfactory amount of a malleable, cushioning material for installation about at least a portion of the front and back regions of at least the front teeth of a patient. The protective odontogenic device may further include a carrier substrate, for containing the satisfactory amount of a malleable, cushioning material prior to installation proximate at least the front teeth of the patient. In the preferred embodiment, the carrier substrate is in a generally horseshoe shaped form.

### BRIEF DESCRIPTION OF THE DRAWINGS

These and other features and advantages of the present invention will be better understood by reading the following detailed description, taken together with the drawings wherein:

FIG. 1 is a schematic top view of the protective odontogenic device according to the present invention;

FIG. 2 his a cross-sectional view of the protective odontogenic device of FIG. 1 along lines 2-2; and

FIG. 3 is a schematic cross-sectional view of the protective odontogenic device in place on a front tooth of a patient.

### DETAILED DESCRIPTION OF THE PREFERRED EMBODIMENTS

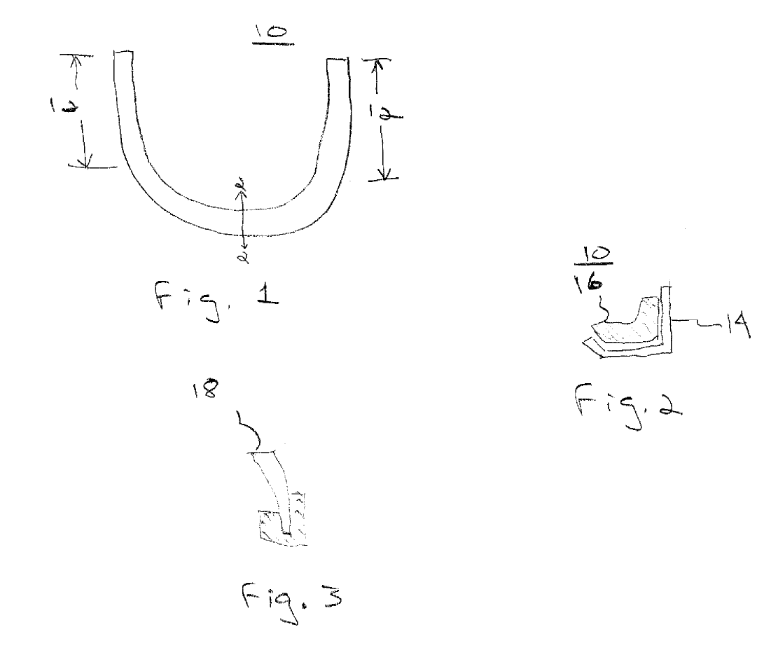

The protective odontogenic device 10, FIG. 1, is typically provided in the shape of a horseshoe which generally matches the arrangement or shape of the patient's teeth although this is not a limitation of the present invention as the odontogenic device may be provided in a straight line which is molded to the shape of the teeth by the surgeon or anesthesiologist when in use. The length of the sides indicated generally by arrows 12 may be adjusted as desired given that the area of the patient's teeth for which protection is sought is more or less along the front of the mouth.

As shown in cross-section in FIG. 2, the protective odontogenic device 10 includes, and the preferred embodiment, a plastic carrier 14 which helps hold or support the malleable, cushioning, protective material 16. The protective material 16 is of a type and quality of material that is malleable; that can take the form of the tooth; and can adhere to and protect the tooth with a cushioning material. An exemplary material is a flowable wax, gel or putty like product having a low melt or flowability point at least as low as or proximate body temperature, or some other similar material. The material must be safe for use in the mouth of a human and must be soft enough to be molded and adhere to the tooth 18, FIG. 3, of the human while providing enough resistance to impact from a surgical instrument to prevent damage to the teeth.

In this manner, the odontogenic device of the present invention may be easily installed by a nurse, surgeon, anesthesiologist or other user of the device, and provides significant resistance to damage to the teeth of a patient by providing a cushion between surgical implements and the teeth of the patient undergoing a surgical procedure.

Modifications and substitutions by one of ordinary skill in the art are considered to be within the scope of the present invention, which is not to be limited except by the allowed claims and their legal equivalents.

The invention claimed is:

1. A protective odontogenic device for minimizing or preventing damage to the front teeth of a patient during a surgical procedure, the odontogenic device comprising a satisfactory amount of a malleable cushioning material for installation about at least a portion of the front and back regions of at least the front teeth of a patient.

2. The protective odontogenic device of claim 1 further including a carrier substrate, for containing said satisfactory amount of a malleable cushioning material prior to installation proximate at least the front teeth of the patient.

3. The protective odontogenic device of claim 2 wherein said carrier substrate is in a generally horseshoe shaped form.

4. A protective odontogenic device for minimizing or preventing damage to the front teeth of a patient during a surgical procedure, the odontogenic device comprising a satisfactory amount of a malleable cushioning material for installation about at least a portion of the front and back regions of at least the front teeth of a patient; and
further including a carrier substrate, for containing said satisfactory amount of a malleable cushioning material prior to installation proximate at least the front teeth of the patient, said carrier substrate having a generally horseshoe shaped form.
